(19) United States
(12) Patent Application Publication
(10) Pub. No.: US 2011/0148665 A1
(43) Pub. Date: Jun. 23, 2011

(54) Method And A Device For Detecting Lack Of Reaction From The Crew Of An Aircraft To An Alarm Related To A Path

(75) Inventors: Frederic Dehais, Toulouse (FR); Laure Christophe, Colomiers (FR); Jean-Michel Merle, Vieille Toulouse (FR); Philippe Pellerin, Auriac Sur Vendinelle (FR)

(73) Assignees: AIRBUS OPERATIONS (SAS), Toulouse (FR); AIRBUS (SAS), Blagnac (FR)

(21) Appl. No.: 12/970,229

(22) Filed: Dec. 16, 2010

(30) Foreign Application Priority Data
Dec. 23, 2009 (FR) 0906296

(51) Int. Cl. G08B 23/00

(52) U.S. Cl. 340/963

(57) ABSTRACT

A method and a device for detecting lack of reaction of the crew of an aircraft to an alarm related to a path.

The device (1) comprises means (6, 8) for automatically emitting at least one auxiliary alert signal for signalling an alarm related to a path of the aircraft, in case the crew does not react to this alarm.

This invention relates to a method and a device for detecting lack of reaction form the crew of an aircraft to an alarm regarding a danger related to a path of the aircraft.

It is known that modern aircrafts, and specially civilian transport planes, are equipped with different alarm devices which emit alarms upon the occurrence of dangers related to the path followed by the aircraft. In particular, It can be mentioned flight anti-collision systems of the TCAC (“Traffic Collision Avoidance System”) type, anti-terrain-collision systems of the TAWS (“Terrain Awareness Warning System”) type, systems for detecting disconnection of the auto-pilot, and systems for detecting windshear. The aim of these different devices is to help the crews recovering control of the path of their aircraft, in case an alarm is emitted.

However, many analyses of flight events, pilot training sessions or research works have shown that crews fail to have a systematic suitable reaction to alarms emitted by such usual alarm devices. In particular, it has been observed that sometimes, pilots do not immediately understand the meaning of these alarms and the actions associated therewith, or do not perceive occurrence thereof. This type of behaviour results from a general issue relating to a wrong awareness of the crew about the actual situation of the aircraft and vicinity thereof. This issue can be generated or worsened by the following situations:
a spatial disorientation which can cause sensory delusions as to how the path and associated alarms are perceived;
a lack of confidence in on board systems. The crew could choose not to believe an alarm, particularly if they have experienced unexpected alarms or they are too confident in their own interpretation of vicinity;
the attention of the crew is focused on a particular piloting task or by alarms triggering at the same time as the path related alarm;
the path related alarm is masked when it is emitted at the same time as other alarms with higher priority; and
the crew is very much concentrated to achieve a particular aim (for example landing the aircraft) which causes it to ignore the path related alarm.

The object of this invention is to overcome these drawbacks. The invention relates to a method for detecting lack of reaction of the crew of an aircraft to an alarm regarding a danger (or hazardous event) related to a path of the aircraft, which in particular helps the crew to be aware of such alarm, if any.

To that end, according to the invention, said method is remarkable in that, automatically:
a) the emitting condition of a plurality of usual alarms regarding said dangers related to the path of the aircraft, which are likely to be emitted on said aircraft is monitored;
b) in case one of said alarms is emitted, a first time interval is determined during which the crew should desirably react to the emitted alarm by implementing at least one procedure to cope with said danger this alarm originates from;
c) the reaction of the crew is monitored; and
d) if at the end of the first time interval from the emission, the crew has not reacted to the alarm, the following operations are performed:
d1) at least one auxiliary alert signal (34, 35, 36) for signalling said alarm is emitted;
d2) a second time interval is determined during which the crew is required to react to the emitted alarm by implementing said procedure to cope with the danger which caused this alarm; and
d3) if at the end of the second time interval the crew has not yet reacted to this alarm, an automatic avoidance operation along an avoidance path to cope with said danger is implemented, said avoidance operation being implemented only if such avoidance path can be calculated.

Thus, thanks to the invention, in case an alarm regarding a danger related to a path of the aircraft is emitted:
the reaction of the crew is automatically monitored in order to ensure they properly implement the procedure required by the hazardous event the alarm originates from; and
in case no proper reaction occurs at the end of a (first) time interval, an auxiliary alert signal detailed below is automatically emitted, in order for the crew and specially the pilot of the aircraft, to become aware of such an alarm.

Thus, the crew is properly informed of any alarm regarding the danger related to a path of the aircraft. This danger can correspond, specially to a hazard of collision between the aircraft and another flying machine or the relief of the terrain over which the aircraft is flying, or a hazard of entering a hazardous area (for example an area with very strong turbulence), if the aircraft keeps flying along the followed path.

Preferably, in step d1), several different auxiliary alert signals are emitted simultaneously.

In addition, according to the invention, if the crew does not react to this auxiliary alert signal, an automatic avoidance operation is implemented, using an auto-pilot of the aircraft, if such an operation is possible, particularly if there is sufficient information for calculating the avoidance path to be followed.

Advantageously:
in step b), said first time interval is determined using information relating to the current state vector of the aircraft and the distance from the current position of the aircraft to the position of the event the alarm originates from; and/or
in step c), the actions performed by the crew on interface means of the aircraft are monitored.

Further, advantageously, in step d1):
it is determined on which interface means is focused the attention of the pilot of the aircraft; and
at least said auxiliary alert signal is emitted on the interface means thus determined.

Within the scope of the present invention, an auxiliary alert signal may correspond:
to the initial alarm, the perception of which by the crew is increased (with respect to the usual condition thereof), for example by flashing of a non flashing visual alarm; or
to a new signal which can be of the same or different type as the alarm.

Besides, if additional usual alarms are emitted simultaneously to said alarm (regarding a danger related to a path of the aircraft), advantageously, in step d1), the relative (sound or light) strength of the latter with respect to said additional alarms (which can be of any type), by decreasing strength thereof.

Further, in a particular embodiment, the following operations are additionally performed:
the current position of the aircraft is assessed;
the relief in the vicinity of said current position is determined, in the direction of the flight path of the aircraft; and
said relief is shown in a flight director horizon, of the ADI (“Attitude Director Indicator”) type of a display for viewing primary flight parameters, of the PFD (“Primary Flight Display”) type.

Preferably, in this particular embodiment, said relief is shown in three dimensions in said flight director horizon which is, usually, in two dimensions.

This invention also relates to a device for detecting the lack of reaction of a crew of an aircraft to an alarm regarding a danger related to a path of the aircraft.

According to the invention, said device is remarkable in that it comprises:
means for automatically monitoring the emitting condition of a plurality of alarms regarding dangers related to the path of the aircraft, which are likely to be emitted in the aircraft;
means for automatically determining, in case one of said alarms is emitted, a first time interval, during which the crew should desirably react to the alarm emitted by implementing at least one procedure to cope with the danger this alarm originates from;
means for automatically monitoring the reaction of the crew;
means for automatically emitting at least one auxiliary alert signal, for signalling the alarm, if at the end of the first time interval from which the alarm is emitted, the crew has not reacted to this alarm;
means for automatically determining a second time interval, during which the crew is required to react to the alarm by implementing said procedure to cope with said danger, said second time interval being determined only if at the end of the first time interval, the crew has not reacted to the alarm; and
means for automatically implementing, if at the end of the second time interval the crew has not yet reacted to the alarm, an automatic avoidance operation (along an avoidance path) for coping with said danger, said avoidance operation being implemented only if such an avoidance path can be calculated.

In one particular embodiment, said device additionally comprises alarm means likely to emit in the aircraft alarms regarding dangers related to the path of the aircraft.

This invention also relates to an aircraft, particularly a civilian transport airplane, which is provided with a device as mentioned above.

The FIGS. of the appended drawing will help better understand how the invention can be implemented. In these figures, identical references refer to similar elements.

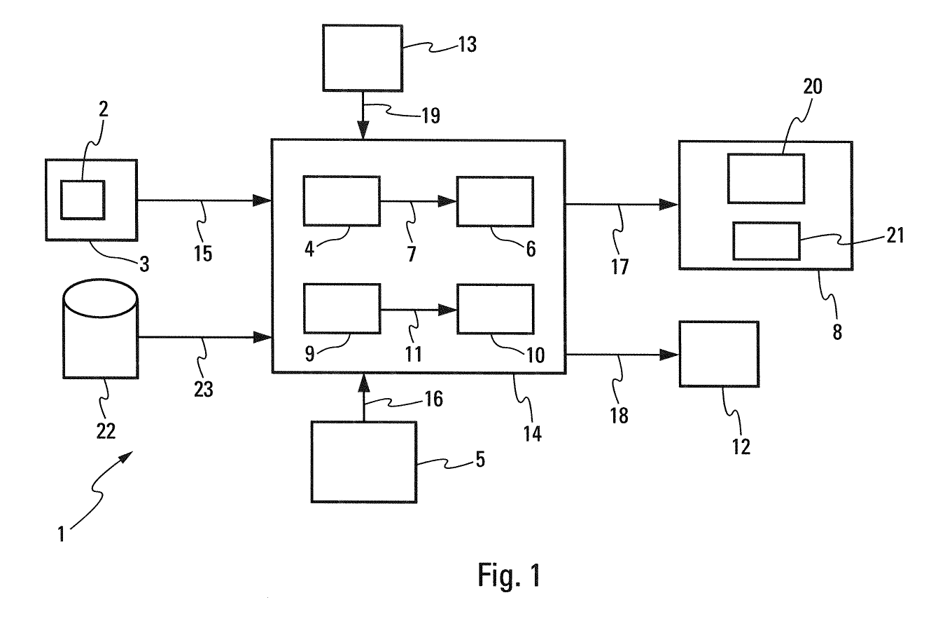

FIG. 1 is a block diagram of a detection device in accordance with the invention.

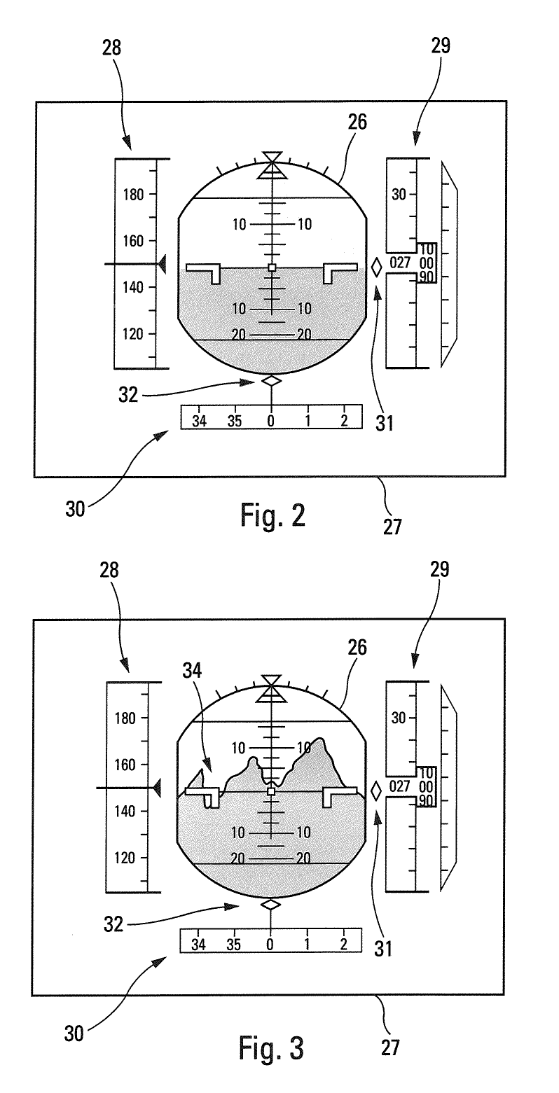

FIGS. 2 to 5 show particular displays of auxiliary signs in accordance with the invention, which are shown on a screen for viewing primary flight parameters.

The device 1 in accordance with the invention and schematically depicted in FIG. 1 is intended to detect lack of reaction of the crew of an aircraft following a particular alarm. Within the scope of this invention, such alarm is generated in the aircraft and regards a danger related to the path followed by said aircraft, particularly a transport plane.

Said device 1 which is on board the aircraft (not shown) comprises usual means 2 for automatically monitoring the emitting condition (alarm emitted or not) of a plurality of alarm devices 3, of which only one has been represented in FIG. 1 for the sake of clarity of drawing. These alarm devices 3 are of the usual type and are formed such as to emit alarms in case of a particular danger related to a path of the aircraft. These alarm devices 3 can correspond, particularly, to flight anti-collision systems of the TCAS type (“Traffic Collision Avoidance System”), anti-terrain-collision systems of the TAWS (“Terrain Awareness Warning System”) type, systems for detecting the auto-pilot disconnection, and systems for detecting windshear.

Preferably, said means 2 are integrated into the alarm devices 3 and are likely to emit, in addition to the emitting condition of the alarm devices 3, the procedure(s) to be implemented by the crew upon an alarm emission, which procedures are intended to cope with the danger this alarm originates from.

Such danger (related to the path) can specially correspond to a collision hazard of the aircraft with another flying machine (particularly a plane) or with the relief of the terrain over which the aircraft is flying, or a risk of entering a hazardous area (for example, an area with very strong turbulence), if it keeps on flying along the followed path.

According to the invention, said device 1 additionally comprises:
means 4 for automatically determining, when the means 2 detect the emission of an alarm by at least one of said alarm devices 3, a first time interval T1, during which the crew should react desirably (but not necessarily required) to the emitted alarm, by implementing at least one procedure (specially received from means 2) which allows it to cope with the danger this alarm originates from, for example an avoidance operation in order to avoid another flying machine or relief;
usual means 5 for automatically monitoring the reaction of the crew following the emission of an alarm. These means 5 are, particularly, able to detect all the actions carried out by the crew on interface means and specially on piloting means, particularly a usual control stick, which are provided in the cockpit of the aircraft. These means 5 can comprise means described in the French patent application FR-2,929,246, for detecting lack of manual control of the aircraft and an auto-pilot disconnection; and
means 6 which are connected through a link 7 to said means 4 and which are formed such as to automatically generate instructions for emitting an auxiliary alert signal which will be displayed to the crew using the signalling means 8.

According to the invention, an auxiliary alert signal enables the emission of an alarm to be signalled and highlighted, and this auxiliary alert signal is only emitted if, at the end of said time interval T1 from the beginning of the alarm, the crew has not reacted to this alarm.

Within the scope of this invention, an auxiliary alert signal may correspond:
to the initial alarm, of which the perception by the crew is strengthened (with respect to the usual condition thereof), for example by flashing of a non flashing usual alarm; or
to a new alert signal, which can be of the same or different type as the initial alarm.

In order to do so, said signalling means 8 can comprise:
means 20 for displaying a visual signal, particularly on a viewing screen 27; and/or
means 21 for emitting an audible alert signal.

Preferably, means 6 and 8 emit simultaneously or successively several different auxiliary alert signals.

Said device 1 additionally comprises:
means 9 for automatically determining a second time interval T2, during which the crew is required (for safety reasons) to react to the alarm by implementing said procedure to cope with said danger. This second time interval T2 is only determined if at the end of said time interval T1 after emitting the alarm, the crew has not reacted to this alarm; and
means 10 which are connected through a link 11 to said means 9 and which generate set points for implementing an automatically avoidance operation which is performed through an auto-pilot device 12 of the usual type. This automatically avoidance operation is implemented if, at the end of time interval T2 (which begins at the end of time interval T1), the crew has not yet reacted to the alarm. This avoidance operation is, for the aircraft, to fly automatically following an avoidance path in order to cope with the danger the alarm originates from. However, this avoidance operation is only implemented if such an avoidance path can be calculated, that is if the required information for automatically calculating (in a usual way) such an avoidance path is available for the device 1. Said device 1 can comprise usual means (not shown) for determining an avoidance path.

Therefore, in case an alarm regarding a danger related to a path of the aircraft is emitted, the device 1 in accordance with the invention:
automatically monitors the reaction of the crew (using means 5) in order to ensure it properly implements the required procedure for avoiding the occurrence of the hazardous event which caused the alarm; and
in case the proper reaction is missing at the end of time interval T1, automatically emits an auxiliary alert signal in order for the crew, and particularly the pilot of the aircraft, to become aware of this alarm.

Thus, the crew is well-informed of any alarms regarding to a danger related to a path of the aircraft. Such danger can particularly correspond to a collision hazard between the aircraft and another flying machine or the relief of the terrain over which the aircraft is flying, if it keeps on flying along the followed path.

In addition, if the crew does not react to this auxiliary alert signal, the device 1 implements an automatic avoidance operation, using the auto-pilot 12, if such an operation is possible, particularly if there is sufficient information for calculating the avoidance path to be followed.

Said device 1 additionally comprises means 13 which include usual inertial information sources and/or a satellite positioning system, for example of the GPS type, and which are able to provide information relating to the current state vector of the aircraft, that is particularly the current position, current vertical speed and current altitude thereof.

In one particular embodiment, said means 4 determine said time interval T1 using the information relative to said current state vector of the aircraft and the distance from the current position of the aircraft to the position of the element (terrain, flying machine, . . . ) the alarm originates from.

Further, in a preferred embodiment, said means 4, 6, 9 and 10 are part of a calculation unit 14 which is connected through links 15, 16, 17, 18 and 19, to said means 3, 5, 8, 12 and 13, respectively.

Besides, if additional usual alarms are emitted at the same time as an alarm (regarding a danger related to a path of the aircraft) in the cockpit of the aircraft, the device 1 can increase the (sound or light) strength of the latter with respect to said additional alarms (which can be of any type), such that it can be perceived by the crew.

In one particular embodiment:
said means 5 determine, in a usual way, on which interface means, for example a viewing screen 27, is focused the attention of the pilot of the aircraft; and
said means 6 and 8 emit said auxiliary alert signal at least on the interface means thus determined.

Further, in one particular embodiment, said device 1 additionally performs the following operations:
it assesses, using means 13, the current position of the aircraft;
it determines the relief in the vicinity of said current position, said relief being for example transmitted by a data base 22 of the relief via un link 23 to the calculating unit 14; and
it shows, using means 8, said relief in a flight director horizon 26, of the ADI (“Attitude Director Indicator”) type, of a screen 27 for viewing the primary flight parameters, of the PFD (“Primary Flight Display”) type, as detailed below.

Said screen 27 can comprise, in a usual way, in addition to said flight director horizon 26, as shown in FIGS. 2 to 5, particularly usual scales 29, 29 and 30 of speed, altitude and heading.

In one particular embodiment, the device 1 is formed in order to show the relief in three dimensions in said flight director horizon 26 which is in two dimensions.

This invention is described hereinafter by means of different examples, referring to FIGS. 2 to 5.

In a first example, the aircraft is in the landing phase, with no visibility, and means 2 detect an alarm which indicates windshear. Means 5 determine that, in this flight phase, the pilots are particularly focused on their primary flight parameter viewing screen 27, such as the one which is depicted in FIG. 2, and particularly on the usual indication means 31 and 32 related to the instrument landing of the ILS (“Instrument Landing System”) type. If, after time interval T1, the pilots have not reacted to the alarm related to windshear, the device 1 will emit (using means 8) different auxiliary alert signals, that is:
a short lighting, for example red, of the background of both screens 27 which are generally available in the cockpit of an aircraft; and
the successive display of messages indicating windshear and requesting a go around, instead of the display of indication means 31 and 32, during time interval T2.

In a second example, the aircraft is still in landing phase with no visibility, and means 2 identify a disconnection of the auto-pilot system, for example the auto-pilot 12. Said means 2 also identify that the audible alarm which is emitted upon such disconnection has been masked by the simultaneous onset of an audible alarm higher priority. Means 5 analyse at the end of time interval T1, that the auto-pilot system is still disconnected and the pilots are not acting on the control stick. Means 5 also determine that, during this flight phase, the pilots are particularly focused on the primary flight parameter viewing screen 27, as depicted in FIG. 2, and particularly on the usual indication means 31 and 32 relating to the instrument landing of the ILS type. Thus, at the end of time interval T1, the device 1 generates the following auxiliary alert signals:
inhibition of the alarm with higher level which masked the auto-pilot system disconnection alarm;
a short light, for example a red one of the background of both primary flight parameter viewing screens 27;
and then the successive display of messages (“Fly your A/F”) in order to prompt pilots to recover control of the aircraft and an alert (“AP OFF”) in order to report the auto-pilot system disconnection.

Further, if in this example the crew has not reacted at the end of time interval T2, the device 1 will automatically trigger the auto-pilot system again, and means 8 will display the appropriate usual information. Further, in a third example, the aircraft is in the landing phase, with no visibility, and means 2 detect an alarm which indicates that the ground is too close due to, for example, mountainous ground. Means 5 determine that, during this flight phase, the pilots are particularly focused on the primary flight parameter viewing screen 27, and especially on the usual indication means 31 and 32 relating to an instrument landing. If, after time interval T1, the pilots have not reacted to this alarm, the device 1 will emit different auxiliary alert signals, that is:
a short light, for example a red one of the background of both screens 27 which are generally available in the cockpit;
the display of a message instructing a pull up, instead of a display of indication means 31 and 32, during time interval T2; and
a strike over display on the flight director horizon 26 of the primary flight parameter viewing screen 27, as depicted in FIG. 3, of a stylized image 34 of the mountainous ground, in order to transmit a strong emotional message.

The visual representation 34 of the relief which therefore directly appears displayed in the primary flight interfaces:
provides simple and relevant perceptive indices in order to assist the crew in adjusting the path in order to avoid the relief; and
transmit a strong emotional content in order to prompt the crew to implement a relief avoidance operation.

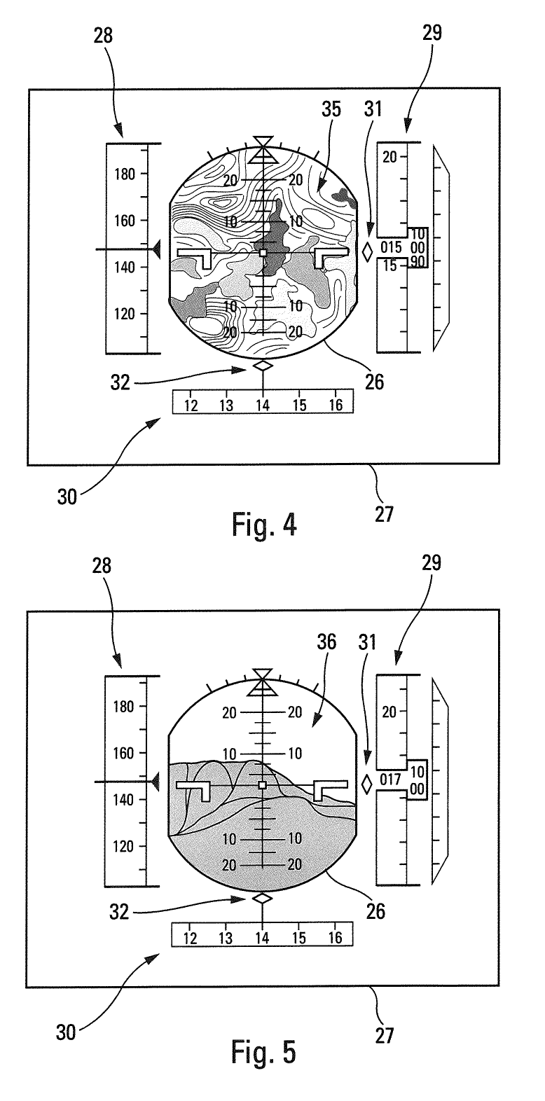

Further, in a fourth example, the aircraft is in the landing phase with no visibility, and means 2 also detect an alarm which indicates that the ground is too close due to the presence of a mountainous ground. Means 5 determine that, in this flight phase, the pilots are particularly focused on the primary flight parameter viewing screen 27, and particularly on the usual indication means 31 and 32 relating to an instrument landing. If, after time interval T1, the pilots have not reacted to this alarm, the device 1 will emit different auxiliary alert signals, that is:
a short (red) lighting of the background of both screens 27 which are available in the cockpit;
the display of a message instructing a pull up, instead of a display of indication means 31 and 32, during time interval T2; and
the strike over display on the flight director horizon 26 of the screen 27, of information about the relief 35 in two dimensions, as depicted in FIG. 4, which information is generally available on a usual navigation display device of the ND (“Navigation Display”) type.

Besides, in a fifth example which is similar to the third and fourth preceding examples, the device 1 can display, in the flight director horizon 26 of the screen 27, a visual representation 36 of the relief in three dimensions, as depicted in FIG. 5.

In order to generate this visual representation 36, the device 1 implements the following operations:
it assesses, using means 13, the current position of the aircraft;
it determines the virtual relief to be displayed, by matching the assessed current position of the aircraft with the data base 22 (received by means 14 via link 23), and
it scales the virtual relief in order to provide a dynamic display thereof, using means 8, in the flight director horizon 26 such that it appears meeting a consistent compliance with the aircraft attitude and tilt information (received, for example, from means 13).

An exemplary application of this latter alternative is the case where an alarm of the pull up type occurs simultaneously with an overspeed alarm, for example as a result of exceeding the allowed speed in an aerodynamic configuration with flaps out. In this case, the device 1 emits auxiliary alert signals corresponding to the following actions:
displaying the relief 36 in three dimensions in the flight director horizon 26;
inhibiting the overspeed-related audible alarms; and
masking, partly, an overspeed alarm usually symbolised by a red ribbon (not shown) on screen 27,
   and this, as long as the pull up type alarm is enabled.

1. A device for detecting lack of reaction of a crew of an aircraft to an alarm regarding the danger related to a path of the aircraft, which is likely to be emitted by alarm means (3), said device comprising means (6, 8) for automatically emitting at least one auxiliary alert signal (34, 35, 36),
characterised in that it comprises:
means (2) for automatically monitoring the emitting condition of a plurality of alarms regarding dangers related to the path of the aircraft, which are likely to be emitted in the aircraft;
means (4) for automatically determining, in case one of said alarms is emitted, a first time interval, during which the crew should desirably react to the alarm emitted by implementing at least one procedure to cope with the danger this alarm originates from;
means (5) for automatically monitoring the reaction of the crew;
said means (6, 8) for automatically emitting an auxiliary alert signal, which emit at least one auxiliary alert signal (34, 35, 36) for signalling the alarm, if at the end of the first time interval from the emitting alarm, the crew has not reacted to this alarm;
means (9) for automatically determining a second time interval, during which the crew is required to react to the alarm by implementing said procedure for coping with said danger, said second time interval being determined only if at the end of the first time interval, the crew has not reacted to the alarm; and
means (10, 12) for automatically implementing, if at the end of the second time interval the crew has not yet reacted to the alarm, an automatic avoidance operation along an avoidance path for coping with said danger, said avoidance operation being implemented only if such an avoidance path can be calculated.

2. The device according to claim 1,
characterised in that it further comprises said alarm means (3) likely to emit in the aircraft alarms regarding dangers related to the path of the aircraft.

3. A method for detecting lack of reaction of a crew of an aircraft to an alarm regarding a danger related to a path of the aircraft, method according to which at least one auxiliary alarm signal (34, 35, 36) can be emitted,
characterised in that, automatically:
a) the emitting condition of a plurality of alarms regarding said dangers related to the path of the aircraft, which can be emitted on said aircraft are monitored;
b) in case one of said alarms is emitted, a first time interval is determined during which the crew should desirably react to the emitted alarm by implementing at least one procedure for coping with said danger this alarm originates from;
c) the reaction of the crew is monitored; and
d) if at the end of the first time interval from the emission, the crew has not reacted to the alarm, the following operations are performed:
d1) at least one auxiliary alert signal (34, 35, 36) for signalling said alarm is emitted;
d2) a second time interval is determined during which the crew is required to react to the emitted alarm by implementing said procedure for avoiding the danger this alarm originates from; and
d3) if at the end of the second time interval the crew has not yet reacted to this alarm, an automatic avoidance operation along an avoidance path for coping with said danger is implemented, said avoidance operation being implemented only if such avoidance path can be calculated.

4. The method according to claim 3,
characterised in that in step b), said first time interval is determined using information regarding the current state vector of the aircraft and the distance from the current position of the aircraft to the position of the event the alarm originates from.

5. The method according to claim 3,
characterised in that in step c), the actions performed by the crew are monitored on interface means of the aircraft.

6. The method according to claim 3,
characterised in that in step d1);
it is determined on which interface means (27) is focused the attention of the pilot of the aircraft; and
said auxiliary alert signal (34, 35, 36) is emitted at least on the interface means (27) thus determined.

7. The method according to claim 3,
characterised in that in step d1), if additional alarms are emitted simultaneously with said alarm regarding a danger related to a path of the aircraft, the strength of the latter is increased with respect to said additional alarms.

8. The method according to claim 3,
characterised in that in step d1), several different auxiliary alert signals are emitted simultaneously.

9. The method according to claim 3,
characterised in that the following operations are additionally performed:
the current position of the aircraft is assessed;
the relief in the vicinity of said current position is determined; and
said relief (34, 35, 36) is shown in a flight director horizon (26) of a screen (27) for viewing the primary flight parameters.

10. The method according to claim 9,
characterised in that said relief (36) is shown in three dimensions in said flight director horizon (26) which is in two dimensions.
